(19) United States
(12) Patent Application Publication
(10) Pub. No.: US 2021/0027568 A1
(43) Pub. Date: Jan. 28, 2021

(54) FOOD VENDING MACHINE AND FOOD VENDING METHOD USING THE SAME

(71) Applicant: YO-KAI EXPRESS INC., Sunnyvale, CA (US)

(72) Inventor: Chih Hung LIN, San Jose, CA (US)

(73) Assignee: YO-KAI EXPRESS INC., Sunnyvale, CA (US)

(21) Appl. No.: 16/935,702

(22) Filed: Jul. 22, 2020

Related U.S. Application Data
(60) Provisional application No. 62/877,503, filed on Jul. 23, 2019.
(60) Provisional application No. 62/899,343, filed on Sep. 12, 2019.
(60) Provisional application No. 62/895,606, filed on Sep. 4, 2019.

(51) Int. Cl. G07F 17/00; G07F 11/54; G07F 9/10

(52) U.S. Cl. CPC G07F 17/0078; G07F 9/105; G07F 11/54

(57) ABSTRACT

A food vending machine and a food vending method are provided. The food vending machine includes a storage device, a movement device, a delivery device and a heating device. The storage device is configured to store at least one food item. The movement device is provided corresponding to the storage device, and is configured to fetch the at least one food item from the storage device and move the at least one food item. The delivery device is provided corresponding to the movement device, and includes at least one delivery portion. The at least one delivery portion includes a placement board. The movement device is configured to move and place the at least one food item on the placement board. The heating device includes a steam portion, a hot water portion and at least one injection member.

### CROSS REFERENCE

This Non-provisional application claims the priority under 35 U.S.C. § 119(a) on U.S. Patent Provisional Application No. 62/877,503 filed on Jul. 23, 2019, U.S. Patent Provisional Application No. 62/899,343 filed on Sep. 12, 2019, and U.S. Patent Provisional Application No. 62/895,606 filed on Sep. 4, 2019, the entire contents of which are hereby incorporated by reference.

### FIELD OF THE INVENTION

The present invention relates to the food vending technology, and more particularly, to a food vending machine and a food vending method using the food vending machine to provide heated food.

### BACKGROUND OF THE INVENTION

Current vending machines can be divided into different categories, for example, vending machines selling hot and cold beverages, vending machines selling non-edible products, and vending machines selling heated food (hereinafter, food vending machines). Among the above, the technology level of vending machines selling heated food is the highest. In addition to appropriately storing heated food by refrigeration or freezing in food vending machine so as to prevent spoiling, these food vending machine also need to be equipped with heaters to heat the refrigerated or frozen food stored therein. Current food vending machine require a long heating time, and a next food item can be heated only after a currently heated food item is completely heated and delivered. Thus, the overall operating efficiency is unsatisfactory, and the selling speed is undesirably affected.

In addition, the power consumption of heating systems of current food vending machines is large, resulting in possible unstable voltage during operation and hence affected heating effects and power system issues.

### SUMMARY OF THE INVENTION

In view of the above, one object of the present invention is to provide a food vending machine capable of improving overall operating efficiency and increasing a selling speed.

In addition, another object of the present invention is to provide a food vending machine suitable for more types of foods to be heated and capable of enhancing heating efficiency without involving manual effort in a heating process.

In addition, another object of the present invention is to provide a food vending method capable of improving overall operating efficiency and increasing a selling speed.

In one embodiment of the present invention, the present invention provides a food vending machine including a storage device, a movement device, a delivery device and a heating device. The storage device is configured to store at least one food item. The movement device is provided corresponding to the storage device, and is configured to fetch the at least one food item from the storage device and move the at least one food item. The delivery device is provided corresponding to the movement device, and includes at least one delivery portion. The at least one delivery portion includes a placement board. The movement device is configured to move and place the at least one food item on the placement board. The heating device includes a steam portion, a hot water portion and at least one injection member. The steam portion and the hot water portion are in communication with the at least one injection member. The at least one injection member is movably provided corresponding to the at least one delivery portion. The steam portion and the hot water portion are configured to inject steam and hot water into the at least one food item on the placement board corresponding thereto through the at least one injection member so as to heat the at least one food item.

In one embodiment of the present invention, the steam portion and the hot water portion are configured to sequentially inject steam and hot water into the at least one food item on the placement board corresponding thereto so as to heat the at least one food item. When the at least one food item is located on the placement board, the at least one injection member moves and inserts into the at least one food item, the steam portion injects steam into the food item through the at least one injection member, and the hot water portion injects hot water into the at least one food item through the at least one injection member.

In one embodiment of the present invention, the food vending machine further includes a turn control module. The turn control module is signally connected to the movement device, the delivery device and heating device. The turn control module is configured to control the movement device such that the movement device sequentially moves plural food items and in turns places the plural food items on the placement board. The turn control module is further configured to control the heating device such that the at least one injection member of the heating device in turns moves and inserts into the plural food items so as to in turns heat the plural food items.

In one embodiment of the present invention, the movement device includes a first movement portion and a second movement portion. The first movement portion is provided corresponding to the storage device and the second movement portion is provided corresponding to the first movement portion and the at least one delivery portion of the delivery device.

In one embodiment of the present invention, the first movement portion includes a first fetching member and a first track. The first fetching member is provided corresponding to the storage device and is movably provided on the first track. The second movement device includes a second fetching member and a second track. The second fetching member is provided corresponding to the first fetching member and the at least one delivery portion of the delivery device and is movably provided on the second track.

In one embodiment of the present invention, the first fetching member is configured to fetch the at least one food item from the storage device and move the at least one food item from a position on the first track to another position. In one embodiment of the present invention, the second fetching member is configured to fetch the at least one food item from the first fetching member and move the at least one food item along the second track to a position corresponding to the at least one delivery portion. In one embodiment of the present invention, the second fetching member places the at least one food item on the placement board of the at least one delivery portion.

In one embodiment of the present invention, the food vending machine further includes a first cabinet and a second cabinet. The first cabinet and the second cabinet are provided adjacent to each other. The storage device and the first movement portion are provided in the first cabinet, and the delivery device, the heating device and the second movement portion are provided in the second cabinet. Further, the first track of the first movement portion extends to the second cabinet.

In one embodiment of the present invention, the at least one delivery portion includes a door panel movably provided. The door panel renders the at least one delivery portion to be closed relative to an exterior when the heating device performs heating and the door panel moves to render the at least one delivery portion to be opened relative to the exterior when the heating device completes heating.

In one embodiment of the present invention, the placement board is movably provided at the at least one delivery portion. The placement board moves out the at least one food item when the heating device completes heating.

In one embodiment of the present invention, the storage device includes plural plural carrier trays coaxially and rotatably provided on a rotating shaft. Each of the carrier trays is configured to hold plural food items such that the plural food items are arranged around the rotating shaft as a center thereof.

In one embodiment of the present invention, the food vending machine further includes a vehicle platform and a vehicle housing. The vehicle platform is configured to carry the storage device, the movement device, the delivery device, and the heating device and includes a wheel portion configured to drive and move the vehicle platform. The vehicle housing is provided on the vehicle platform to cover the storage device, the movement device and the delivery device with the at least one delivery portion being uncovered from the vehicle housing.

In one embodiment of the present invention, the food vending machine further includes a first display screen. The first display screen and the at least one delivery portion are located on a side surface of the vehicle housing.

In one embodiment of the present invention, the food vending machine further includes a second display screen. The second display screen is located on an obverse surface of the vehicle housing. The side surface and the food vending machine surface of the vehicle housing are substantially perpendicular to each other.

In one embodiment of the present invention, the vehicle platform further includes a vehicle light portion, and the vehicle light portion and the second display screen are located on the same surface.

In one embodiment of the present invention, the vehicle housing further includes a sunshade provided in a collapsible manner on the side surface of the vehicle housing, and the sunshade selectively shields the first display screen or has an included angle relative to the first display screen.

In one embodiment of the present invention, the food vending machine further includes an electronic money sensing device an electronic money sensing device. The electronic money sensing device is located on the side surface of the vehicle housing.

In one embodiment of the present invention, the present invention further provides a food vending machine including a storage device, a movement device, a delivery device, a heating device and an energy conversion device. The storage device is configured to store at least one food item. The movement device is provided corresponding to the storage device and configured to fetch the at least one food item from the storage device and move the at least one food item. The delivery device is provided corresponding to the movement device and includes at least one placement device. The at least one placement device includes a casing. An interior of the casing is configured to place the at least one food item therein. The heating device is connected to the casing and is configured to heat the at least one food item in the interior of the casing. The energy conversion device includes an energy control module, an energy storage module, an internal transmission line and an external transmission line. The energy control module is electrically connected to the energy storage module. The internal transmission line connects the energy storage module to the heating device, the delivery device, the storage device and the movement device. The external transmission line is connected to the energy storage module and is connected to an external energy source.

In one embodiment of the present invention, the energy control module controls the energy storage module to transmit electric energy through the internal transmission line to the heating device, the delivery device, the storage device and the movement device.

In one embodiment of the present invention, the energy control module controls the energy storage module to receive the electric energy through the external transmission line and store the electric energy from the external energy source.

In one embodiment of the present invention, the energy control module controls the energy storage module to transmit the electric energy through the internal transmission line to the heating device, the delivery device, the storage device and the movement device, and to simultaneously receive the electric energy through the external transmission line and store the electric energy from the external energy source.

In one embodiment of the present invention, the energy control module controls the energy storage module to transmit the electric energy through the internal transmission line to the heating device, the delivery device, the storage device and the movement device, and to simultaneously receive the electric energy through the external transmission line and receive and transmit the electric energy from the external energy source to the heating device, the delivery device, the storage device and the movement device.

In one embodiment of the present invention, the energy conversion device further includes a voltage conversion module electrically connected to the energy control module and the energy storage module.

In one embodiment of the present invention, after the voltage conversion module converts a first voltage of the electric energy of the external energy source to a second voltage, the energy control module controls the energy storage module to receive and store the electric energy having the second voltage.

In one embodiment of the present invention, after the voltage conversion module converts a third voltage of the electric energy of the energy storage module to a fourth voltage, the energy control module controls the energy storage module to transmit the electric energy having the fourth voltage to the heating device, the delivery device, the storage device and the movement device.

In one embodiment of the present invention, the present invention further provides a food vending method, including the steps as follows. At least one food item is in a storage device. The at least one food item is fetched from the storage device and the at least one food item is moved by a movement device provided corresponding to the storage device. The at least one food item is moved and placed on a placement board of at least one delivery portion of the delivery device provided corresponding to the movement device. Steam is injected by a steam portion and hot water is injected by a hot water portion into the at least one food item on the placement board corresponding thereto through at least one injection member of a heating device so as to heat the at least one food item. The steam portion and the hot water portion are in communication with the at least one injection member being movably provided corresponding to the at least one delivery portion.

In one embodiment of the present invention, steam and hot water are sequentially injected into the at least one food item on the placement board corresponding thereto so as to heat the at least one food item. When the at least one food item is located on the placement board, the at least one injection member moves and inserts into the at least one food item, the steam portion injects steam into the food item through the at least one injection member, and the hot water portion injects hot water into the at least one food item through the at least one injection member.

In one embodiment of the present invention, the movement device is controlled such that the movement device sequentially moves a plural food items and in turns places the plural food items on the placement board. The heating device is controlled such that the at least one injection member of the heating device in turns moves and inserts into the plural food items so as to in turns heat the plural food items.

In one embodiment of the present invention, a first fetching member is used to fetch the at least one food item from the storage device and move the at least one food item from a position on a first track to another position. A second fetching member is used to fetch the at least one food item from the first fetching member and move the at least one food item along a second track to a position corresponding to the at least one delivery portion. The second fetching member is used to place the at least one food item on the placement board of the at least one delivery portion. The first fetching member is provided corresponding to the storage device and is movably provided on the first track, and the second fetching member is provided corresponding to the first fetching member and the at least one delivery portion of the delivery device and is movably provided on the second track.

In one embodiment of the present invention, the at least one delivery portion is rendered to be closed relative to an exterior when heating is performed and the at least one delivery portion is rendered to be opened relative to the exterior when heating is completed.

In one embodiment of the present invention, the at least one food item is moved out when heating is completed.

In conclusion, the food vending machine and the food vending method according to the embodiments of the present invention are capable of quickly heating or defrosting refrigerated or frozen food in a food item by using steam, and further heating food in the at least one food item by using hot water. Further, the plural at least one delivery portion can accelerate a delivery speed. Thus, the food vending machine and the food vending method according to the embodiments of the present invention offer better overall operating efficiency and provides a better selling speed.

Detailed features and advantages of the present invention are described in detail by way of embodiments below. The disclosure of the embodiments is sufficient for a person skilled in the art to understand the technical content of the present invention and accordingly implement the present invention. In addition, on the basis of the disclosed content, claims and drawings of the description of the present application, a person skilled in the art could easily understand the objects and advantages of the present invention.

### BRIEF DESCRIPTION OF THE DRAWINGS

The foregoing summary, as well as the following detailed descriptions of the invention, will be better understood when read in conjunction with the appended drawings. In the drawings:

FIG. 1 is a schematic diagram of a food vending machine according to one embodiment of the present invention;

FIG. 2 is a schematic diagram of the food vending machine in FIG. 1, with some of the outer components omitted to present the internal structure thereof;

FIG. 3 is a block schematic diagram of a food vending machine according to one embodiment of the present invention;

FIG. 4 is a schematic diagram of a first cabinet of a food vending machine according to one embodiment of the present invention;

FIG. 5 is a partial schematic diagram of a second cabinet of a food vending machine according to one embodiment of the present invention;

FIG. 6 is a partial schematic diagram of the second cabinet of the food vending machine in FIG. 5 in a rear viewing angle;

FIG. 7 is a partial schematic diagram of the first cabinet of the food vending machine in FIG. 4;

FIG. 8 is a top schematic diagram of the first cabinet of the food vending machine in FIG. 4;

FIG. 9 is a schematic diagram of a mobile food vending machine according to another embodiment of the present invention;

FIG. 10 is a block diagram of a food vending machine according to another embodiment of the present invention; and

FIG. 11 is a flowchart of a food vending method according to one embodiment of the present invention.

### DESCRIPTION OF THE INVENTION

The following embodiments when read with the accompanying drawings are made to clearly exhibit the above-mentioned and other technical contents, features and effects of the present disclosure. Through the exposition by means of the specific embodiments, people would further understand the technical means and effects of the present disclosure adopted to achieve the above-indicated objectives. Moreover, as the contents disclosed herein can be readily understood and implemented by a person skilled in the art, all equivalent changes or modifications which do not depart from the concept of the present disclosure shall be encompassed by the appended claims.

Furthermore, the ordinals recited in the specification and the claims such as “first”, “second” and so on are intended only to describe the elements claimed and imply or represent neither that the claimed elements have any proceeding ordinals, nor the sequence between one claimed element and another claimed element or between steps of a manufacturing method. The use of these ordinals is merely to differentiate one claimed element having a certain designation from another claimed element having the same designation.

Furthermore, the terms recited in the specifications and the claims such as “above”, “over”, or “on” are intended not only directly contact with the other element, but also intended indirectly contact with the other element.

### Embodiment 1: Food Vending Machine

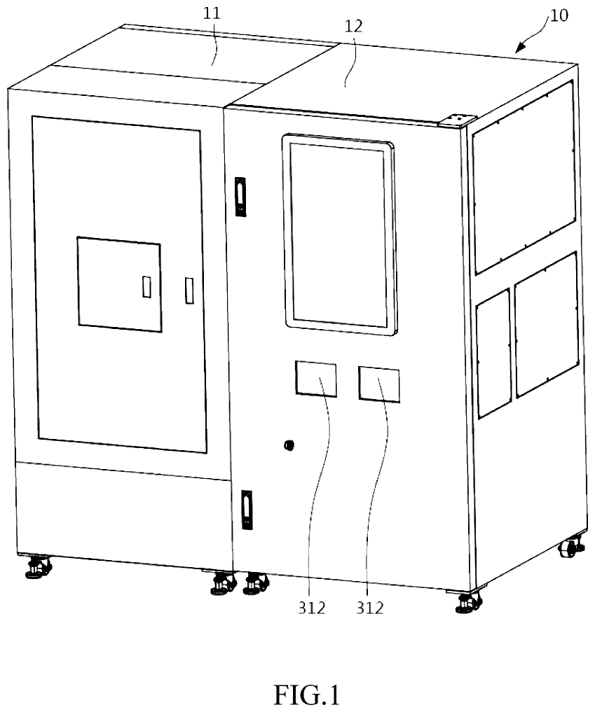

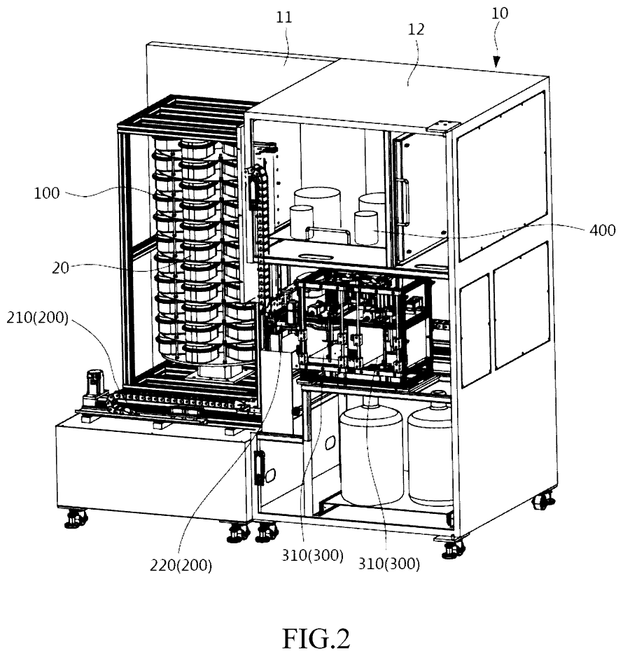

Referring to FIG. 1 and FIG. 2, FIG. 1 shows a schematic diagram of a food vending machine according to one embodiment of the present invention, and FIG. 2 shows a schematic diagram of the food vending machine 10 in FIG. 1, with some of the outer components omitted to present the internal structure thereof. In this embodiment, the food vending machine 10 is configured to sell plural food items 20, and the plural food items 20 carry food to be heated, for example but not limited to, frozen ramen or udon noodles. In other embodiments, the food vending machine 10 can also sell soup or hot beverages to be brewed.

As shown in FIG. 1 and FIG. 2, in this embodiment, the food vending machine 10 includes a storage device 100, a movement device 200, a delivery device 300 and a heating device 400. The storage device 100 is configured to store at least one food item 20. The movement device 200 is provided corresponding to the storage device 100 and the delivery device 300, and is configured to fetch the at least one food item 20 from the storage device 100 and move the at least one food item 20 such that the at least one food item 20 is moved to the delivery device 300. The delivery device 300 is provided corresponding to the movement device 200, and includes at least one delivery portion 310. The at least one delivery portion 310 is configured to hold one food item 20 to be heated and deliver the at least one food item 20 having been heated. The heating device 400 is provided corresponding to the individual at least one delivery portion 310, and can heat the individual food items 20 in the individual at least one delivery portion 310. In other words, the heating device 400 can heat two food items 20 simultaneously or in turns by using two delivery portions 310, and the two delivery portions 310 can simultaneously or in turns deliver two heated food items 20. In some embodiments, the delivery device 300 can include three or more delivery portions 310, so as to simultaneously or in turns heat and deliver three or more food items 20.

As shown in FIG. 1 and FIG. 2, in this embodiment, the food vending machine 10 further includes a first cabinet 11 and a second cabinet 12, and the first cabinet 11 and the second cabinet 12 are adjacent to each other and can be detachably assembled together. The storage device 100 and a first movement portion 210 are provided in the first cabinet 11, and a delivery device 300, a heating device 400 and a second movement portion 220 are provided in the second cabinet 12. With the design of the first cabinet 11 and the second cabinet 12, different components can be separated so as to facilitate repair and maintenance of the food vending machine 10.

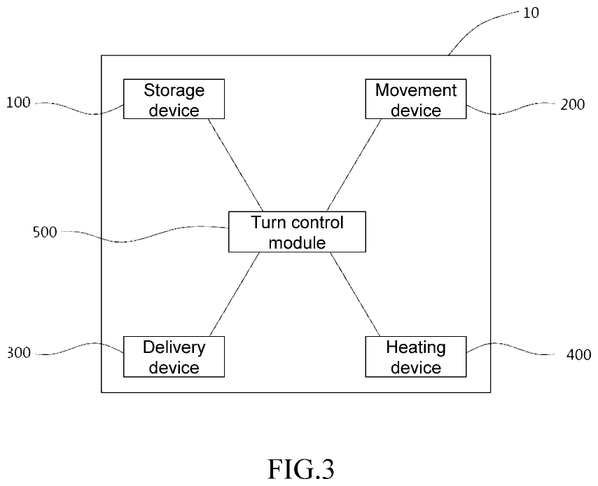

Referring to FIG. 3, FIG. 3 shows a schematic diagram of the food vending machine 10 according to one embodiment of the present invention. In this embodiment, the food vending machine 10 further includes a turn control module 500, which is signally connected to the movement device 200, the delivery device 300 and the heating device 400. The turn control module 500 is provided in, for example, an electronic control system of the food vending machine 10, and can be in form of software, hardware, or a combination of software and hardware. The turn control module 500 is configured to control the movement device 200, such that the movement device 200 sequentially moves the plural food items 20 and in turns moves the at least one food item 20 to the at least one delivery portion 310. The turn control module 500 further controls the heating device 400, such that the heating device 400 in turns heats the at least one food item 20 located in at least one of the delivery portion 310. In this embodiment, the term “in turn” is defined as, for example but not limited to, a successive and alternating operating mode.

For example, the turn control module 500 can control the movement device 200, such that the movement device 200 first fetches from the storage device 100 and moves the first food item 20 to one of the at least one delivery portion 310, and the turn control module 500 can then control the heating device 400 and the delivery portion 310 to perform heating and delivery procedures on the first food item 20. While the first food item 20 is being processed in the delivery portion 310, the turn control module 500 can in turns control the movement device 200, such that the movement device 200 returns to the position corresponding to the storage device 100, and fetches from the storage device 100 and moves the second food item 20 to the other of the at least one delivery portion 310, and then the turn control module 500 can control the heating device 400 and the delivery portion 310 to perform heating and delivery procedures on the second food item 20. While the second food item 20 is being heated and delivered, if the first food item 20 has been delivered, the turn control module 500 can in turns control the movement device 200, such that the movement device 200 returns to the position corresponding to the storage device 100, and fetches from the storage device 100 and moves the third food item 20 to the delivery portion 310 previously holding the first food item 20, and the turn control module 500 can then control the heating device 400 and the delivery portion 310 to perform heating and delivery procedures on the third food item 20. In this embodiment, the food items 20 are heated sequentially and separately; however, in an alternative embodiment, the food items 20 are delivered sequentially whereas are heated and delivered simultaneously, and thus the consumers shall obtain the food items 20 simultaneously.

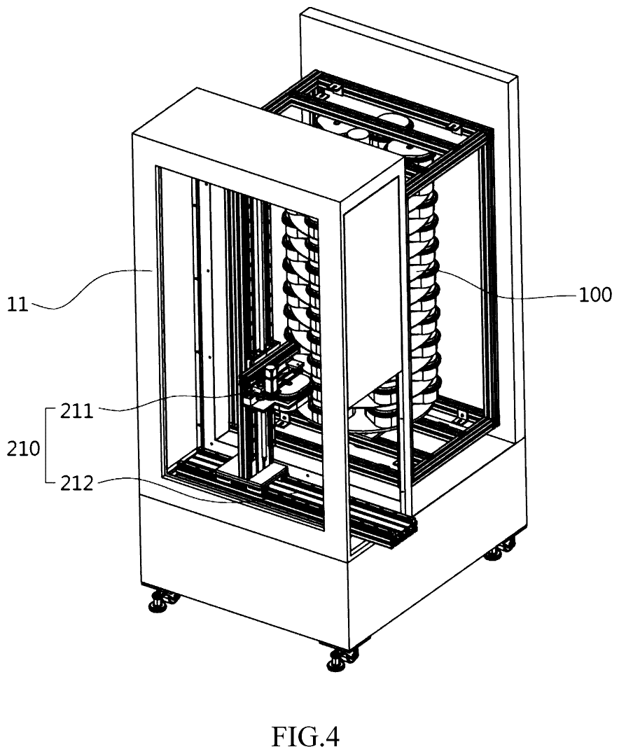

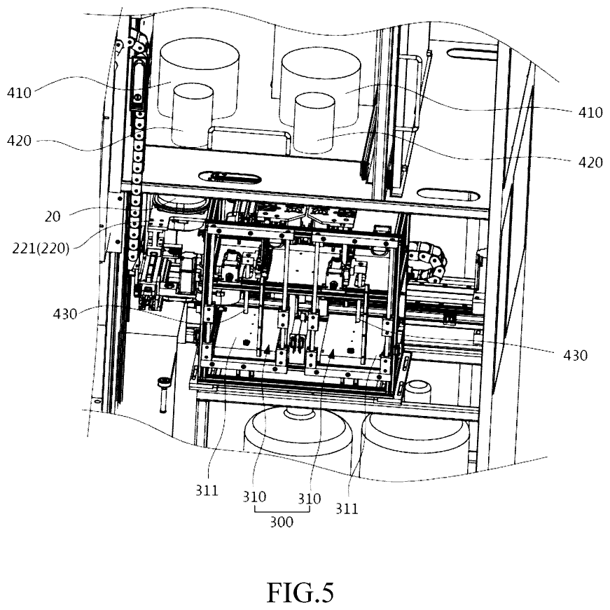

Referring to FIG. 4 and FIG. 5, FIG. 4 shows a schematic diagram of the first cabinet 11 of the food vending machine 10 according to one embodiment of the present invention, and FIG. 5 shows a partial schematic diagram of the second cabinet 12 of the food vending machine 10 according to one embodiment of the present invention. As shown in FIG. 5, in this embodiment, each delivery portion 310 includes a placement board 311, and the movement device 200 is configured to move and place the at least one food item 20 on the placement board 311 of one of the two at least one delivery portion 310. In addition, the heating device 400 includes a steam portion 410, a hot water portion 420 and at least one injection member 430. The steam portion 410 and the hot water portion 420 can be in communication with the two injection members 430 by corresponding pipelines. The at least one injection member 430, is configured to example but not limited to, a tubular object made of a high temperature resistant and hard metal. The two injection members 430 are movably provided corresponding to at least one of the delivery portion 310 respectively, and the steam portion 410 and the hot water portion 420 are configured to inject steam and hot water into the at least one food item 20 on the placement board 311 corresponding thereto via one of the two injection members 430, so as to heat the food held in the at least one food item 20.

For example, the turn control module 500 can in turns control the movement device 200, such that the movement device 200 in turns fetches from the storage device 100 and moves two food items 20 into two placement portions, and sequentially places the two food items 20 on the two placement boards 311 of the two at least one delivery portion 310. Further, the turn control module 500 can control the at least one injection member 430 of the heating device 400 and in turns move the injection member 430 to be corresponded to the at least one food item 20, so as to in turns heat the food held in the at least one food item 20.

In this embodiment, the steam portion 410 and the hot water portion 420 are configured to sequentially inject steam and hot water into the at least one food item 20 on the placement board 311 corresponding thereto so as to heat the food in the at least one food item 20. For example, when the at least one food item 20 is placed on the placement board 311, the corresponding injection member 430 moves and inserts into the at least one food item 20, and the steam portion 410 then first injects high-temperature steam into the at least one food item 20 through the at least one injection member 430 to quickly defrost the frozen food in the at least one food item 20 and then stops outputting steam. Next, the hot water portion 420 injects hot water into the at least one food item 20 through the at least one injection member 430, such that the frozen food is heated at an appropriate speed in the hot water. After heating is completed, the at least one injection member 430 moves away from the at least one food item 20, and the at least one food item 20 in the delivery portion 310 at this point has undergone the heating procedure and are ready to be delivered.

As shown in FIG. 4 and FIG. 5, in this embodiment, the movement device 200 includes a first movement portion 210 and a second movement portion 220. The first movement portion 210 is provided corresponding to the storage device 100, and is located in the first cabinet 11. The second movement portion 220 is provided corresponding to the first movement portion 210 and the at least one delivery portion 310 of the delivery device 300, and is located in the second cabinet 12. In this embodiment, the first movement portion 210 includes a first fetching member 211 and a first track 212, and is provided corresponding to the storage device and movably provided on the first track 212. Further, the first track 212 of the first movement portion 210 extends to the second cabinet 12.

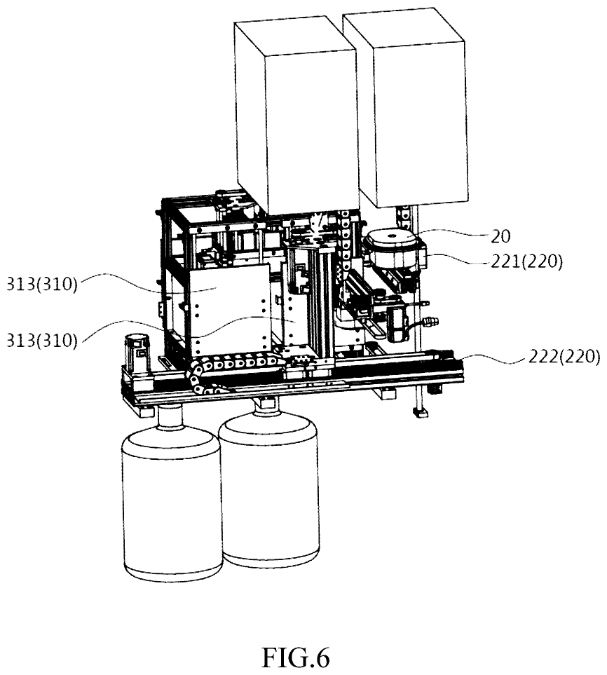

Referring to FIG. 6, FIG. 6 shows a partial schematic diagram of the second cabinet 12 of the food vending machine 10 in FIG. 5 in a rear viewing angle. As shown in FIG. 5 and FIG. 6, in this embodiment, the second movement portion 220 includes a second fetching member 221 and a second track 222; the second fetching member 221 is provided corresponding to the first fetching member 211 and the at least one delivery portion 310 of the delivery device 300, and is movably provided on the second track 222. As shown in FIG. 4 to FIG. 6, in this embodiment, the first fetching member 211 can fetch from the storage device 100 the at least one food item 20, and can move from a position on the first track 212 (for example, a position at which the at least one food item 20 is fetched) to another position (for example, a position on the first track 212 in the second cabinet 12). When the first fetching member 211 having fetched the at least one food item 20 moves to the position on the first track 212 in the second cabinet 12, the second fetching member 221 can move along the second track 222 to the position corresponding to the first fetching member 211 and can obtain the at least one food item 20 from the first fetching member 211. Next, the second fetching member 221 can move along the second track 222 to the position corresponding to one delivery portion 310 of the two at least one delivery portion 310, and place the at least one food item 20 on the placement board 311 in the corresponding delivery portion 310, so as to facilitate subsequent heating and delivery procedures.

As shown in FIG. 1, FIG. 2 and FIG. 5, in this embodiment, each delivery portion 310 further includes a door panel 312. Each door panel 312 is movably provided at the corresponding delivery portion 310. When the heating device 400 performs heating, the door panel 312 of the corresponding delivery portion 310 is configured to rendering the delivery portion 310 to be closed relative to the exterior (as shown in FIG. 1, the door panel 312 is in a closed state); when the heating device 400 completes heating, the door panel 312 of the corresponding placement portion is moved, such that the delivery portion 310 is open relative to the exterior. That is to say, the door panel 312 in FIG. 1 can, for example, move upwards, so as to render the delivery portion 310 to be open relative to the exterior. A mechanism for moving the door panel 312 upwards can be implemented by a current technique and is omitted herein.

As shown in FIG. 5, in this embodiment, the placement board 311 is movably provided in the corresponding delivery portion 310. For example, when the heating device 400 completes a heating procedure, the placement board 311 of the corresponding delivery portion 310 moves towards the exterior (a forward direction in FIG. 5, that is, a direction of a consumer), such that the at least one food item 20 to be delivered can be moved to the exterior as well, so as to facilitate a consumer to take the at least one food item 20. A mechanism for moving the placement board 311 forward can be implemented by a current technique and is omitted herein.

As shown in FIG. 6, in this embodiment, each delivery portion 310 further includes a rear plate 313, and the rear plate 313 is movably provided at the corresponding delivery portion 310. For example, when the second fetching member 221 moves along the second track 222 to the position of the corresponding delivery portion 310, the rear plate 313 of the corresponding delivery portion 310 can, for example, move upwards, such that the corresponding delivery portion 310 opens relative to the second fetching member 221. At this point, the second fetching member 221 can enter the corresponding delivery portion 310 through the open rear plate 313, and place the at least one food item 20 on the placement board 311 corresponding thereto, so as to facilitate subsequent heating and delivery procedures.

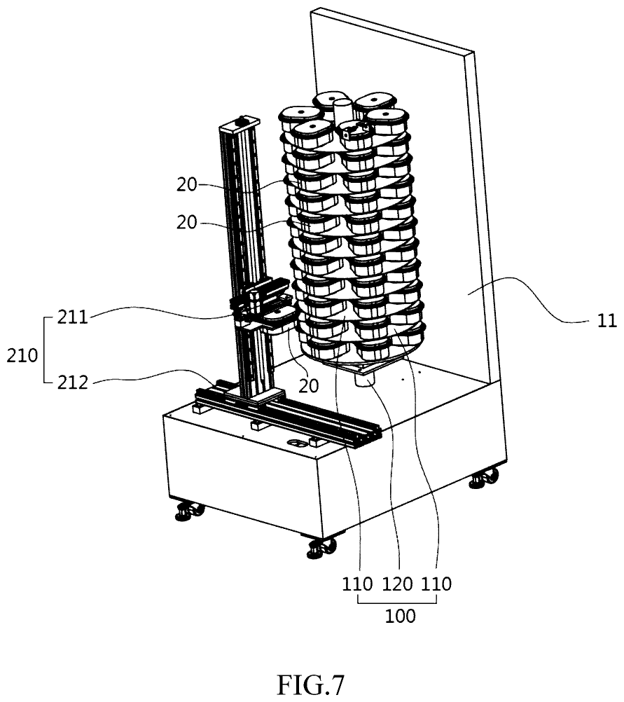

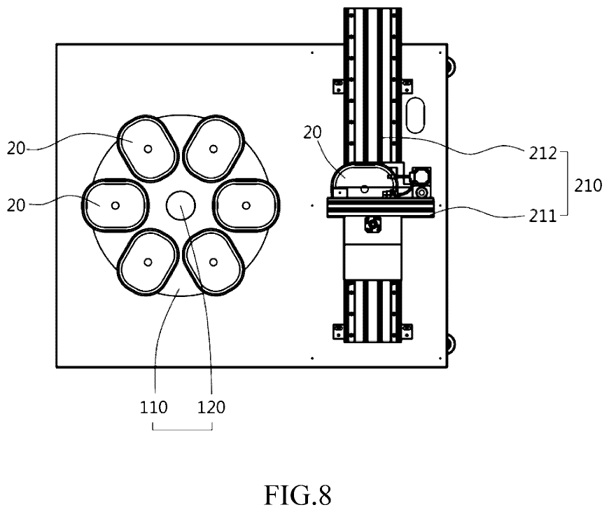

Refer to FIG. 7 and FIG. 8, FIG. 7 shows a partial schematic diagram of the first cabinet 11 of the food vending machine 10 in FIG. 4, and FIG. 8 is a top schematic diagram of the first cabinet 11 of the food vending machine 10 in FIG. 4. In this embodiment, the storage device 100 includes plural carrier trays 110 and a rotating shaft 120. The carrier trays 110 are provided on the rotating shaft 120 and sequentially overlays one another along an axial direction of the rotating shaft 120, and the carrier trays 110 can rotate coaxially by regarding the rotating shaft 120 as a center of rotation. Each of the carrier trays 110 is configured to holding plural food items 20, and the at least one food item 20 on each of the carrier trays 20 are arranged around the rotating shaft 120 as a center thereof.

For example, when the first fetching member 211 and the storage device 100 operate collaboratively, the first fetching member 211 can move along the axial direction of the rotating shaft 120 to become aligned with the corresponding carrier tray 110; the corresponding carrier tray 110 can rotate relative to the rotating shaft 120 as a center such that the corresponding food item 20 becomes aligned with the first fetching member 211, and the first fetching member 211 at this point can take out the corresponding food item 20 from the carrier tray 110. In some embodiments, all of the carrier trays 110 are fixed at the rotating shaft 120. Thus, when the rotating shaft 120 rotates, all of the carrier trays 110 rotate synchronously. In practice, the at least one food item 20 of the same type of food (e.g., ramen of a first flavor) can be placed on corresponding positions of all of the carrier trays 110; that is, these food items 20 are located on the same row of the axial direction of the rotating shaft 120. Hence, for example but not limited, the efficiency of replenishment of the storage device 100 and fetching of the at least one food item 20 by the movement device 200 can be promoted.

### Embodiment 2: Food Vending Machine

Current vending machine are placed in a fixed manner or at fixed points in specific regions; that is to say, a consumer can only spontaneously get to a location of a food vending machine in order to operate and purchase merchandise in the food vending machine.

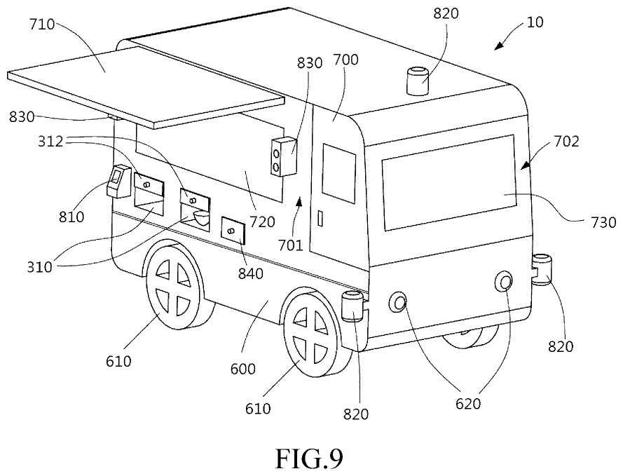

Referring to FIG. 1, FIG. 2 and FIG. 9, FIG. 9 is a schematic diagram of a mobile food vending machine according to one embodiment of the present invention. In FIG. 1, FIG. 2 and FIG. 9, the mobile food vending machine includes a storage device 100, a movement device 200, a delivery device 300, a heating device 400, a vehicle platform 600 and a vehicle housing 700. The vehicle platform 600 and the vehicle housing 700 are omitted in FIG. 1 and FIG. 2.

The storage device 100, the movement device 200, the delivery device 300, and the heating device 400 are similar to those as described in EMBODIMENT 1, and descriptions thereof are thus not repeated. As shown in FIG. 9, in this embodiment, the vehicle platform 600 includes a wheel portion 610 which drives and moves the vehicle platform 600 such that the food vending machine 10 in overall is provided with a movement capability. For example, the vehicle platform 600 can include a power source, such as a fuel engine or an electric engine, which can drive and rotate the wheel portion 610. When the wheel portion 610 comes into contact with the ground, the wheel portion 610 can drive and move the vehicle platform 600 on the ground. The configuration of the power source can refer to the conventional technology and is omitted herein.

As shown in FIG. 1, FIG. 2 and FIG. 9, in this embodiment, the vehicle housing 700 is provided on the vehicle platform 600 and covers the storage device 100, the movement device 200 and the delivery device 300 from outside, and the at least one delivery portion 310 are revealed from the vehicle housing 700, with associated details to be described shortly.

In this embodiment, the vehicle housing 700 covers the first cabinet 11 and the second cabinet 12 from outside. In other embodiments, housings of the first cabinet 11 and the second cabinet 12 can also directly serve as a part of the vehicle housing 700.

It should be understood that, the overall shape of the food vending machine 10 in FIG. 1 and FIG. 2, and the configurations of internal structures such as the storage device 100, the movement device 200 and the delivery device 300 therein, can be modified and changed as desired according to requirements. For example, the storage device 100 and the first cabinet 11 in FIG. 1 and FIG. 2 are located on the left side of the delivery device 300 and the second cabinet 12. However, a person skilled in the art can also modify the storage device 100 and the first cabinet 11 to locate on the right side of the delivery device 300 and the second cabinet 12, so as to satisfy appearance requirements of the vehicle housing 700.

As shown in FIG. 9, in this embodiment, the food vending machine 10 further includes a sunshade 710 and a first display screen 720. The sunshade 710 is provided in a collapsible manner on a side surface 701 of the vehicle housing 700, and the first display screen 720 and the at least one delivery portion 310 are together located on the side surface 701 of the vehicle housing 700. The sunshade 710 can block the sun and rain; the first display screen 720 can be used for displaying information such as photographs, descriptions and prices of food sold by the food vending machine 10, and operation instructions of the food vending machine 10. The sunshade 710 can selectively shield the first display screen 720. For example, when the food vending machine 10 is in a course of moving or is under a not-in-use state, the sunshade 710 can be collapsed and hence completely shield the first display screen 720 so as to protect the first display screen 720. When the food vending machine 10 reaches a predetermined position and is open for use, the sunshade 710 can be collapsed to have an included angle relative to the first display screen 720 (as shown in FIG. 9). At this point in time, the first display screen 720 can be revealed to be viewed by consumers, and consumers can stand below the sunshade 710 and operate the food vending machine 10.

As shown in FIG. 9, in this embodiment, the food vending machine 10 further includes a second display screen 730. The second display screen 730 is located on an obverse surface 702 of the vehicle housing 700, and the side surface 701 and the obverse surface 702 of the vehicle housing 700 are, for example but not limited to, substantially perpendicular to each other. During the course of moving the food vending machine 10, the second display screen 730 can face a movement direction and further display information associated with the food vending machine 10 such as the brand of the food vending machine 10 and types of food sold, thus allowing more passersby to learn the information associated with the food vending machine 10 by means of the second display screen 730.

As shown in FIG. 9, in this embodiment, the vehicle platform 600 further includes a vehicle light portion 620, and the vehicle light portion 620 and the second display screen 730 are located on the same surface. That is to say, during the course of moving the food vending machine 10, the vehicle light portion 620 similarly faces the movement direction and illuminates road conditions ahead to produce an alert effect for passersby.

As shown in FIG. 9, in this embodiment, the food vending machine 10 further includes an electronic money sensing device 810 located on the side surface 701 of the vehicle housing 700. In this embodiment, the electronic money sensing device 810 can be disposed at a position near the first display screen 720 or the at least one delivery portion 310, so as to facilitate a consumer to make a payment by electronic money by means of the electronic money sensing device 810 while the consumer operates the food vending machine 10. In some embodiments, the electronic money sensing device 810 can be used for sensing, for example but not limited to, credit cards, Easycards or mobile payment means.

As shown in FIG. 9, in this embodiment, the food vending machine 10 further includes a road condition detection device 820 located on the vehicle housing 700. The road condition detection device 820 can be used for detecting road conditions. For example, the road condition detection device 820 can be a radar device or an imaging device, and it can determine road conditions by radar waves or by real-time images during the course of moving the food vending machine 10, so as to achieve assisted driving or automated driving. In this embodiment, the road condition detection device 820 is in a quantity of at least three, which are respectively located on the top and bottom parts of the vehicle housing 700 and are provided as facing the movement direction of the food vending machine 10.

As shown in FIG. 9, in this embodiment, the food vending machine 10 further includes a speaker device 830 located on the vehicle housing 700. The speaker device 830 can be used for broadcasting information associated with the food vending machine 10, such as the brand of the food vending machine 10 and types of food sold. In this embodiment, the food vending machine 10 further includes a dining utensil placement portion 840 for placing dining utensils. Furthermore, the food utensil placement portion 840 can be provided on the side surface 701 of the vehicle housing 700 and near the at least one delivery portion 310, so as to facilitate consumers to take out dining utensils from the dining utensil placement portion 840.

The food vending machine according to FIG. 9 of the present invention is capable of quickly heating or defrosting refrigerated or frozen food in a food item by using steam, and further heating food in the at least one food item by using hot water. Moreover, using the turn control module for controlling the storage device, the movement device, the plural at least one delivery portion of the delivery device and the heating device, the components can operate collaboratively in turn, thereby significantly improving heating and delivery speed and efficiency. Thus, the food vending machine according to the embodiments of the present invention offers better overall operating efficiency and provides a better selling speed.

### Embodiment 3: Food Vending Machine

In this embodiment, the present invention provides a food vending machine suitable for more types of foods to be heated and capable of enhancing heating efficiency without involving manual effort in a heating process.

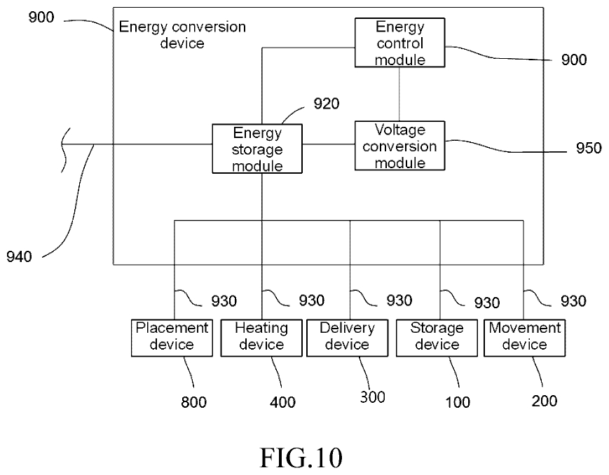

Referring to FIG. 1, FIG. 2, and FIG. 10, FIG. 10 is a block diagram of a food vending machine according to another embodiment of the present invention. Similar to the food vending machine in EMBODIMENT 1, the food vending machine in this embodiment includes a storage device 100, a movement device 200, a delivery device 300, a heating device 400 and an energy conversion device 900. The energy conversion device connects to the food vending machine and provides energy to the food vending machine while the machine is switched on.

As shown in FIG. 10, in this embodiment, the energy control module 910 is electrically connected to the energy storage module 920, the internal transmission line 930 connects the energy storage module 920 to the heating device 400, the delivery device 300, the storage device 100 and the movement device 200, and the external transmission line 940 is connected to the energy storage module 920 and is connected to an external energy source. The external energy source is, for example, a commercial power grid, and thus one end of the external transmission line 940 can be a plug corresponding to a commercial power socket and be inserted in the commercial power socket.

In this embodiment, for example but not limited to, the energy control module 910 and the energy storage module 920 can be integrated into a unit, and the energy storage module 920 can include one or more batteries. The energy control module 910 and the energy storage module 920 are provided in the housing, and the energy control module 910 can control the energy storage module 920, such that the energy storage module 920 transmits electric energy through the internal transmission line 930 to the heating device 400, the delivery device 300, the storage device 100 and the movement device 200, so as to power the heating device 400, the delivery device 300, the storage device 100 and the movement device 200. The energy control module 910 can further control the energy storage module 920, such that the energy storage module 920 can receive through the external transmission line 940 and store electric energy from the external energy source.

In some embodiments, the electric energy needed for operating the heating device 400, the delivery device 300, the storage device 100 and the movement device 200 may be entirely from the energy storage module 920. In a situation where the power consumption of the heating device 400, the delivery device 300, the storage device 100 and the movement device 200 is large, the energy storage module 920 can output a voltage or current larger than that of an external power supply to the heating device 400, the delivery device 300, the storage device 100 and the movement device 200. In some embodiments, the energy control module 910 can control the energy storage module 920 to transmit electric energy through the internal transmission line 930 to the heating device 400, the delivery device 300, the storage device 100 and the movement device 200, and the energy control module 910 can further control the energy storage module 920 to receive through the external transmission line 940 and store the electric energy from the external energy source while electric energy is outputted to the heating device 400, the delivery device 300, the storage device 100 and the movement device 200.

In some embodiments, the electric energy needed for operating the heating device 400, the delivery device 300, the storage device 100 and the movement device 200 may be concurrently be from the energy storage module 920 and an external power supply. That is to say, while the energy storage module 920 transmits the electric energy storage therein to the heating device 400, the delivery device 300, the storage device 100 and the movement device 200, the energy control module 910 further simultaneously transmits the electric energy from the external energy source to the heating device 400, the delivery device 300, the storage device 100 and the movement device 200. In a situation where the power consumption of the heating device 400, the delivery device 300, the storage device 100 and the movement device 200 is large, the energy storage module 920 and the external power supply can together output a sufficient voltage or current to the heating device 400, the delivery device 300, the storage device 100 and the movement device 200. In some embodiments, the energy control module 910 can control the energy storage module 920 to transmit electric energy through the internal transmission line 930 to the heating device 400, the delivery device 300, the storage device 100 and the movement device 200, and the energy control module 910 can further control the energy storage module 920 to receive and transmit through the external transmission line 940 the electric energy from the external energy source to the heating device while electric energy is outputted to the heating device 400, the delivery device 300, the storage device 100 and the movement device 200.

As shown in FIG. 10, in this embodiment, the energy conversion device 900 further includes a voltage conversion module 950. The voltage conversion module 950 is electrically connected to the energy control module 910 and the energy storage module 920. The energy control module 910, the energy storage module 920 and the voltage conversion module 950 can be, for example but not limited to, integrated into one unit.

In some embodiments, the voltage conversion module 950 receives the electric energy from the external energy source through the external transmission line 940, and the electric energy received from the external energy source has a first voltage. The voltage conversion module 950 first converts the first voltage to a second voltage, and the energy control module 910 controls the energy storage module 920 to receive and store the electric energy having the second voltage, wherein the first voltage can be greater than or smaller than the second voltage.

In some embodiments, when the energy storage module 920 needs to output electric energy to the heating device 400, the delivery device 300, the storage device 100 and the movement device 200, the voltage conversion module 950 first converts a third voltage of the electric energy of the energy storage module 920 to a fourth voltage, and the energy control module 910 then controls the energy storage module 920 to transmit the electric energy having the fourth voltage to the heating device 400, the delivery device 300, the storage device 100 and the movement device 200, wherein, for example but not limited to, the third voltage can be greater than or smaller than the fourth voltage and the second voltage can be equal to the third voltage.

In some embodiments, the energy control module 910 can control the voltage conversion module 950 to receive 110 V electric energy from the external energy source through the external transmission line 940, the voltage conversion module 950 converts the 110 V electric energy to 220 V electric energy and transmits the 220 V electric energy to the energy storage module 920, and the energy storage module 920 stores the electric energy. When the heating device 400, the delivery device 300, the storage device 100 and the movement device 200 need to operate, the energy control module 910 can control the energy storage module 920 to output the 220 V electric energy, control the voltage conversion module 950 to convert the electric energy outputted to 500 V electric energy, and transmit the 500 V electric energy through the internal transmission line 930 to the heating device 400, the delivery device 300, the storage device 100 and the movement device 200, enabling the heating device 400, the delivery device 300, the storage device 100 and the movement device 200 to operate by using the electric energy.

In some embodiments, the energy control module 910 can control the voltage conversion module 950 to receive 110 V electric energy from the external energy source through the external transmission line 940, the voltage conversion module 950 converts the 110 V electric energy to 220 V electric energy and transmits the 220 V electric energy to the energy storage module 920, and the energy storage module 920 stores the electric energy. When the heating device 400, the delivery device 300, the storage device 100 and the movement device 200 need to operate, the energy control module 910 can control the energy storage module 920 to output the 220 V electric energy, the energy control module 910 can control the voltage conversion module 950 to receive the 110 V electric energy from the external energy source through the external transmission line 940, the voltage conversion module 950 converts the 110 V electric energy to 220 V electric energy, and the energy control module 910 can together transmit the 220 V electric energy stored and outputted by the energy storage module 920 and the 220 V electric energy from the external energy source and converted by the voltage conversion module 950 to the heating device 400, the delivery device 300, the storage device 100 and the movement device 200, enabling the heating device 400, the delivery device 300, the storage device 100 and the movement device 200 to operate by using the electric energy.

In some embodiments, the energy control module 910 directly transmits the electric energy from an external power supply to the heating device 400, the delivery device 300, the storage device 100 and the movement device 200 to operate the heating device 400, the delivery device 300, the storage device 100 and the movement device 200. While the heating device 400, the delivery device 300, the storage device 100 and the movement device 200 operate accordingly, in the event of a power failure or blackout or an unstable voltage/current, the energy control module 910 controls the energy storage module 920 to continually transmit the electric energy stored to the heating device 400, the delivery device 300, the storage device 100 and the movement device 200, enabling the heating device 400, the delivery device 300, the storage device 100 and the movement device 200 to operate continuously without power interruption in the event of a power failure or blackout.

In some embodiments, after the energy control module 910 controls the voltage conversion module 950 to receive electric energy from an external energy source through the external transmission line 940 and converts the voltage of the electric energy, the electric energy from the external power supply is directly outputted to the heating device 400, the delivery device 300, the storage device 100 and the movement device 200 to operate the heating device 400, the delivery device 300, the storage device 100 and the movement device 200. While the heating device 400, the delivery device 300, the storage device 100 and the movement device 200 operate accordingly, in the event of a power failure or blackout or an unstable voltage/current, the energy control module 910 continually transmits, after controlling the voltage conversion module 950 to receive the electric energy stored in the energy storage module 920 and convert the voltage of the electric energy, the voltage converted electric energy stored in the energy storage module 920 to the heating device 400, the delivery device 300, the storage device 100 and the movement device 200, enabling the heating device 400, the delivery device 300, the storage device 100 and the movement device 200 to operate continuously without power interruption in the event of a power failure or blackout.

### Embodiment 4: Food Vending Method

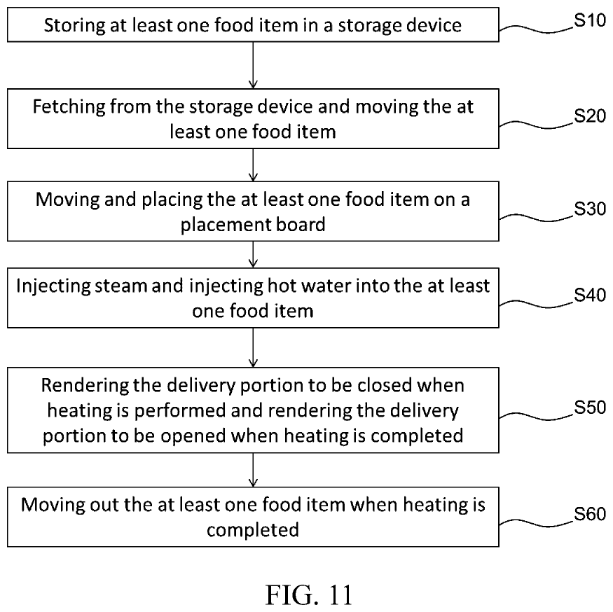

In this embodiment, the present invention further provides a food vending method. Referring to FIG. 1, FIG. 2, and FIG. 11, FIG. 11 is a flowchart of a food vending method according to one embodiment of the present invention. In one embodiment, the food vending method including the steps as follows.

In Step S10, at least one food item is in a storage device.

In Step S20, the at least one food item is fetched from the storage device and the at least one food item is moved by a movement device provided corresponding to the storage device.

In one embodiment of the present invention, a first fetching member is used to fetch the at least one food item from the storage device and move the at least one food item from a position on a first track to another position. A second fetching member is used to fetch the at least one food item from the first fetching member and move the at least one food item along a second track to a position corresponding to the at least one delivery portion. The second fetching member is used to place the at least one food item on the placement board of the at least one delivery portion. The first fetching member is provided corresponding to the storage device and is movably provided on the first track, and the second fetching member is provided corresponding to the first fetching member and the at least one delivery portion of the delivery device and is movably provided on the second track.

In Step S30, the at least one food item is moved and placed on a placement board of at least one delivery portion of the delivery device provided corresponding to the movement device.

In Step S40, steam is injected by a steam portion and hot water is injected by a hot water portion into the at least one food item on the placement board corresponding thereto through at least one injection member of a heating device so as to heat the at least one food item. The steam portion and the hot water portion are in communication with the at least one injection member being movably provided corresponding to the at least one delivery portion.

In one embodiment of the present invention, steam and hot water are sequentially injected into the at least one food item on the placement board corresponding thereto so as to heat the at least one food item. When the at least one food item is located on the placement board, the at least one injection member moves and inserts into the at least one food item, the steam portion injects steam into the food item through the at least one injection member, and the hot water portion injects hot water into the at least one food item through the at least one injection member.

In one embodiment of the present invention, the movement device is controlled such that the movement device sequentially moves a plural food items and in turns places the plural food items on the placement board. The heating device is controlled such that the at least one injection member of the heating device in turns moves and inserts into the plural food items so as to in turns heat the plural food items.

Further, in Step S50, the at least one delivery portion is rendered to be closed relative to an exterior when heating is performed and the at least one delivery portion is rendered to be opened relative to the exterior when heating is completed.

In Step S50, the at least one food item is moved out when heating is completed.

While preferred embodiments of the present invention have been shown and described herein, it will be obvious to those skilled in the art that such embodiments are provided by way of example only and can be implemented in combinations. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

I/We claim:

1. A food vending machine, comprising:
a storage device configured to store at least one food item;
a movement device provided corresponding to the storage device and configured to fetch the at least one food item from the storage device and move the at least one food item;
a delivery device provided corresponding to the movement device and comprising at least one delivery portion comprising a placement board, wherein the movement device is configured to move and place the at least one food item on the placement board; and
a heating device comprising a steam portion, a hot water portion and at least one injection member, wherein the steam portion and the hot water portion are in communication with the at least one injection member being movably provided corresponding to the at least one delivery portion, and the steam portion and the hot water portion are configured to inject steam and hot water into the at least one food item on the placement board corresponding thereto through the at least one injection member so as to heat the at least one food item.

2. The food vending machine according to claim 1, wherein the steam portion and the hot water portion are configured to sequentially inject steam and hot water into the at least one food item on the placement board corresponding thereto so as to heat the at least one food item such that, when the at least one food item is located on the placement board, the at least one injection member moves and inserts into the at least one food item, the steam portion injects steam into the food item through the at least one injection member, and the hot water portion injects hot water into the at least one food item through the at least one injection member.

3. The food vending machine according to claim 2, further comprising:
a turn control module signally connected to the movement device, the delivery device and heating device, wherein the turn control module is configured to control the movement device such that the movement device sequentially moves a plurality of food items and in turns places the plurality of food items on the placement board, and the turn control module is further configured to control the heating device such that the at least one injection member of the heating device in turns is moved to be corresponded to the plurality of food items so as to in turns heat the plurality of food items.

4. The food vending machine according to claim 1, wherein the movement device comprises a first movement portion provided corresponding to the storage device and a second movement portion provided corresponding to the first movement portion and the at least one delivery portion of the delivery device.

5. The food vending machine according to claim 4, wherein the first movement portion comprises a first fetching member and a first track such that the first fetching member is provided corresponding to the storage device and is movably provided on the first track, and the second movement device comprises a second fetching member and a second track such that the second fetching member is provided corresponding to the first fetching member and the at least one delivery portion of the delivery device and is movably provided on the second track.

6. The food vending machine according to claim 5, wherein the first fetching member is configured to fetch the at least one food item from the storage device and move the at least one food item from a position on the first track to another position, the second fetching member is configured to fetch the at least one food item from the first fetching member and move the at least one food item along the second track to a position corresponding to the at least one delivery portion, and the second fetching member places the at least one food item on the placement board of the at least one delivery portion.

7. The food vending machine according to claim 4, further comprising:
a first cabinet and a second cabinet provided adjacent to each other such that the storage device and the first movement portion are provided in the first cabinet, and the delivery device, the heating device and the second movement portion are provided in the second cabinet,
wherein the first track of the first movement portion extends to the second cabinet.

8. The food vending machine according to claim 1, wherein the at least one delivery portion comprises a door panel movably provided such that the door panel renders the at least one delivery portion to be closed relative to an exterior when the heating device performs heating and the door panel moves to render the at least one delivery portion to be opened relative to the exterior when the heating device completes heating.

9. The food vending machine according to claim 8, wherein the placement board is movably provided at the at least one delivery portion such that the placement board moves out the at least one food item when the heating device completes heating.

10. The food vending machine according to claim 1, wherein the storage device comprises a plurality of carrier trays coaxially and rotatably provided on a rotating shaft, wherein each of the carrier trays is configured to hold a plurality of food items such that the plurality of food items is arranged around the rotating shaft as a center thereof.

11. The food vending machine according to claim 1, further comprising:
a vehicle platform configured to carry the storage device, the movement device, the delivery device, and the heating device and comprising a wheel portion configured to drive and move the vehicle platform; and
a vehicle housing provided on the vehicle platform to cover the storage device, the movement device and the delivery device with the at least one delivery portion being uncovered from the vehicle housing.

12. The food vending machine according to claim 11, further comprising:
a first display screen, wherein the first display screen and the at least one delivery portion are located on a side surface of the vehicle housing.

13. The food vending machine according to claim 12, further comprising:
a second display screen located on an obverse surface of the vehicle housing, wherein the side surface and the food vending machine surface of the vehicle housing are substantially perpendicular to each other.

14. The food vending machine according to claim 13, wherein the vehicle platform further comprises a vehicle light portion, and the vehicle light portion and the second display screen are located on the same surface.

15. The food vending machine according to claim 12, wherein the vehicle housing further comprises a sunshade provided in a collapsible manner on the side surface of the vehicle housing, and the sunshade selectively shields the first display screen or has an included angle relative to the first display screen.

16. The food vending machine according to claim 12, further comprising:
an electronic money sensing device, located on the side surface of the vehicle housing.

17. The food vending machine according to claim 1, further comprises an energy conversion device, connecting to and providing energy to the food vending machine, wherein the energy conversion device comprises an energy control module, an energy storage module, an internal transmission line and an external transmission line, wherein the energy control module is electrically connected to the energy storage module, the internal transmission line connects the energy storage module to the heating device, the delivery device, the storage device and the movement device, and the external transmission line is connected to the energy storage module and is connected to an external energy source.

18. A food vending machine, comprising:
a storage device configured to store at least one food item;
a movement device provided corresponding to the storage device and configured to fetch the at least one food item from the storage device and move the at least one food item;
a delivery device provided corresponding to the movement device and comprising at least one placement device comprising a casing, wherein an interior of the casing is configured to place the at least one food item therein;
a heating device connected to the casing and configured to heat the at least one food item in the interior of the casing; and
an energy conversion device, connecting to and providing energy to the food vending machine, comprising an energy control module, an energy storage module, an internal transmission line and an external transmission line, wherein the energy control module is electrically connected to the energy storage module, the internal transmission line connects the energy storage module to the heating device, the delivery device, the storage device and the movement device, and the external transmission line is connected to the energy storage module and is connected to an external energy source.

19. The food vending machine according to claim 18, wherein the energy control module controls the energy storage module to transmit electric energy through the internal transmission line to the heating device, the delivery device, the storage device and the movement device.

20. The food vending machine according to claim 19, wherein the energy control module controls the energy storage module to receive the electric energy through the external transmission line and store the electric energy from the external energy source.

21. The food vending machine according to claim 20, wherein the energy control module controls the energy storage module to transmit the electric energy through the internal transmission line to the heating device, the delivery device, the storage device and the movement device, and to simultaneously receive the electric energy through the external transmission line and store the electric energy from the external energy source.

22. The food vending machine according to claim 20, wherein the energy control module controls the energy storage module to transmit the electric energy through the internal transmission line to the heating device, the delivery device, the storage device and the movement device, and to simultaneously receive the electric energy through the external transmission line and receive and transmit the electric energy from the external energy source to the heating device, the delivery device, the storage device and the movement device.

23. The food vending machine according to claim 18, wherein the energy conversion device further comprises a voltage conversion module electrically connected to the energy control module and the energy storage module.

24. The food vending machine according to claim 21, wherein after the voltage conversion module converts a first voltage of the electric energy of the external energy source to a second voltage, the energy control module controls the energy storage module to receive and store the electric energy having the second voltage.

25. The food vending machine according to claim 21, wherein after the voltage conversion module converts a third voltage of the electric energy of the energy storage module to a fourth voltage, the energy control module controls the energy storage module to transmit the electric energy having the fourth voltage to the heating device, the delivery device, the storage device and the movement device.

26. A food vending method, comprising the steps of:
storing at least one food item in a storage device;
fetching the at least one food item from the storage device and moving the at least one food item by a movement device provided corresponding to the storage device;
moving and placing the at least one food item on a placement board of at least one delivery portion of the delivery device provided corresponding to the movement device; and
injecting steam by a steam portion and injecting hot water by a hot water portion into the at least one food item on the placement board corresponding thereto through at least one injection member of a heating device so as to heat the at least one food item, wherein the steam portion and the hot water portion are in communication with the at least one injection member being movably provided corresponding to the at least one delivery portion.

27. The food vending method according to claim 26, wherein the step of injecting steam and hot water comprises a step of:
sequentially injecting steam and hot water into the at least one food item on the placement board corresponding thereto so as to heat the at least one food item such that, when the at least one food item is located on the placement board, the at least one injection member moves and inserts into the at least one food item, the steam portion injects steam into the food item through the at least one injection member, and the hot water portion injects hot water into the at least one food item through the at least one injection member.

28. The food vending method according to claim 27, wherein the step of sequentially injecting steam and hot water into the at least one food item comprises steps of:
controlling the movement device such that the movement device sequentially moves a plurality of food items and in turns places the plurality of food items on the placement board; and
controlling the heating device such that the at least one injection member of the heating device in turns moves and inserts into the plurality of food items so as to in turns heat the plurality of food items.

29. The food vending method according to claim 26, wherein the step of fetching the at least one food item from the storage device and moving the at least one food item comprises steps of:
using a first fetching member to fetch the at least one food item from the storage device and move the at least one food item from a position on a first track to another position;
using a second fetching member to fetch the at least one food item from the first fetching member and move the at least one food item along a second track to a position corresponding to the at least one delivery portion, and
using the second fetching member to place the at least one food item on the placement board of the at least one delivery portion,
wherein the first fetching member is provided corresponding to the storage device and is movably provided on the first track, and the second fetching member is provided corresponding to the first fetching member and the at least one delivery portion of the delivery device and is movably provided on the second track.

30. The food vending method according to claim 26, further comprising a step of:
rendering the at least one delivery portion to be closed relative to an exterior when heating is performed and rendering the at least one delivery portion to be opened relative to the exterior when heating is completed.

31. The food vending method according to claim 30, further comprising a step of:
moving out the at least one food item when heating is completed.
